(19) United States
(12) Patent Application Publication
(10) Pub. No.: US 2025/0131429 A1
(43) Pub. Date: Apr. 24, 2025

(54) SYSTEMS AND METHODS FOR USER AUTHENTICATION VIA GENERATED MESSAGE

(71) Applicant: Capital One Services, LLC, McLean, VA (US)

(72) Inventors: Jeffrey Carlyle WIEKER, Falls Church, VA (US); Jeffrey RULE, Chevy Chase, MD (US); Paul FORT, Westbury, NY (US)

(73) Assignee: Capital One Services, LLC, McLean, VA (US)

(21) Appl. No.: 18/918,832

(22) Filed: Oct. 17, 2024

Related U.S. Application Data
(60) Provisional application No. 63/544,973, filed on Oct. 20, 2023.

(51) Int. Cl. G06Q 20/40

(52) U.S. Cl. CPC G06Q 20/401

(57) ABSTRACT

The present disclosure provides systems and methods for authenticating a user before performing a transaction. For example, a user can initiate a transaction and a software application can collect information about the transaction and the user, generate a message, such as a message compliant with the ISO 20022 standard, and send the message to an account processing system. The processing system can determine whether the transaction is secure, then proceed with either allowing or denying the transaction.

### CROSS-REFERENCE TO RELATED APPLICATION

This application claims the priority of U.S. Provisional Patent Application No. 63/544,973, filed on Oct. 20, 2023, the contents of which are incorporated herein by reference in their entireties.

### FIELD OF THE DISCLOSURE

The present disclosure relates to systems and methods for user authentication for performing an online transaction.

### BACKGROUND

Many consumers today have multiple financial accounts among which they perform many different kinds of online transactions. But managing transactions across multiple accounts with different account providers can be complex and time-consuming, and users often have limited control and visibility over their transactions across various accounts. In addition, inefficient coordination between users, administrators, and account providers can lead to transaction delays and friction points while diminishing the user experience and potentially reducing the number of transactions that can be performed.

Further, users are often required to perform an authentication prior to accessing an account. However, traditional authentication methods can be cumbersome and may involve multiple steps. Users often have limited control and visibility over their transactions across various accounts. This can add further transaction delays and friction points while further diminishing the user experience and potentially reducing the number of transactions that can be performed.

These and other deficiencies exist. Therefore, there is a need to provide systems and methods for user authentication for performing an online transaction that overcome these deficiencies.

### SUMMARY OF THE DISCLOSURE

In some aspects, the techniques described herein relate to a system for authenticating a user for a transaction, the system including: a software application configured to: receive, from a user device associated with an account holder associated with a bank, a transaction request; receive, from the user device, a user datum associated with the account holder; encrypt the user datum using user datum encryption information; transmit to each of a plurality of account processing systems a user account query including the encrypted user datum, wherein each account processing system is associated with a different account provider and has been provisioned with the user datum encryption information; receive, by the software application from at least one of the plurality of account processing systems, a response including a notification that the account holder has a transaction account processed by that account processing system; transmit, by the software application to the user device, a confirmation request identifying the account providers associated with the at least one of the plurality of account processing systems; receive, by the software application from the user device, a confirmation response including identification of a selected account provider; collect, from a merchant processor, transaction profile information associated with the transaction; analyze the transaction profile information; determine, based on the analysis of the transaction profile information, a security assessment of the transaction, wherein the security assessment indicates a measure of security associated with the transaction; transmit to the user device upon determining that the transaction is insecure, an authentication request; receive, from the user device, a user authentication credential; generate a message including a plurality of details about the transaction; transmit the message to the selected account provider; and receive, from the selected account provider, a response including either an authorization of the transaction or a rejection of the transaction.

In some aspects, the techniques described herein relate to a method for authenticating a user for a transaction, the method including the steps of: receiving, by the software application from a user device associated with an account holder associated with a bank, a transaction request; receiving, by the software application from the user device, a user datum associated with the account holder; encrypting, by the software application, the user datum using user datum encryption information; transmitting by the software application to each of a plurality of account processing systems a user account query including the encrypted user datum; receiving, by the software application from at least one of the plurality of account processing systems, a response including a notification that the account holder has a transaction account processed by that account processing system; transmitting, by the software application to the user device, a confirmation request identifying the account providers associated with the at least one of the plurality of account processing systems; receiving, by the software application from the user device, a confirmation response including identification of a selected account provider; collecting, by the software application from a merchant processor, transaction profile information associated with the transaction; analyzing by the software application the transaction profile information; determining, by the software application based on the analysis of the transaction profile information, a security assessment of the transaction, wherein the security assessment indicates a measure of security associated with the transaction; transmitting by the software application to the user device upon determining that the transaction is insecure, an authentication request; receiving, from the user device, a user authentication credential; generating by the software application a message including a plurality of details about the transaction; transmitting the message to the selected account provider; and receiving, by the software application from the selected account provider, a response including either an authorization of the transaction or a rejection of the transaction.

In some aspects, the techniques described herein relate to a non-transitory computer readable medium containing computer executable instructions that, when executed by a computer hardware arrangement, cause the computer hardware arrangement to perform procedures including: receiving, from a user device associated with an account holder associated with a bank, a transaction request; receiving, from the user device, a user datum associated with the account holder; encrypting the user datum using user datum encryption information; transmitting to each of a plurality of account processing systems a user account query including the encrypted user datum; receiving, from at least one of the plurality of account processing systems, a response including a notification that the account holder has a transaction account processed by that account processing system; transmitting, to the user device, a confirmation request identifying the account providers associated with the at least one of the plurality of account processing systems; receiving, from the user device, a confirmation response including identification of a selected account provider; collecting, from a merchant processor, transaction profile information associated with the transaction; analyzing the transaction profile information; determining, based on the analysis of the transaction profile information, a security assessment of the transaction, wherein the security assessment indicates a measure of security associated with the transaction; transmitting to the user device upon determining that the transaction is insecure, an authentication request; receiving, from the user device, a user authentication credential; generating a message including a plurality of details about the transaction; transmitting the message to the selected account provider; and receiving, from the selected account provider, a response including either an authorization of the transaction or a rejection of the transaction.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1 illustrates a system according to an exemplary embodiment.

FIG. 2 illustrates a contactless card according to an exemplary embodiment.

FIG. 3 illustrates a contact pad of a contactless card according to an exemplary embodiment.

FIGS. 4A-4C illustrate user device graphical user interfaces according to an exemplary embodiment.

FIGS. 5A-5B illustrate a system according to an exemplary embodiment.

FIG. 6 illustrates a process according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Systems and methods of the present disclosure are directed to a system designed to authenticate users during transactions, particularly in the context of financial transactions. The system employs a software application that carries out several steps. The application receives transaction requests and user data from a device linked to an account holder of a bank and encrypts the user data using specific encryption information. The application then sends the encrypted user data to various account processing systems, each associated with a different account provider. The application receives responses from at least one of these processing systems, indicating whether the account holder has a transaction account with that particular provider. The application then communicates with the user device to confirm the selected account provider. The system gathers information about the transaction from a merchant processor and analyzes this data. Based on the analysis, the application assesses the security level of the transaction, essentially determining how safe or risky it is. If the system deems the transaction insecure, the application requests user authentication from the user device. Upon receiving the user's authentication credentials, the application generates a message containing various transaction details. This message is sent to the selected account provider. Finally, the system awaits a response from the account provider, which can either authorize or reject the transaction. In essence, this system provides a comprehensive process for verifying and securing user-initiated transactions through a combination of data encryption, account provider confirmation, transaction analysis, and user authentication.

The message generated by the software application can be an Extensible Markup Language (XML) message compliant with the International Organization for Standardization (ISO) 20022 standard. ISO 20022 is an international messaging standard for the financial industry, and XML is one of the widely used syntaxes to represent data in this standard. ISO 20022 defines a common language and syntax for the exchange of financial information between financial institutions, businesses, and regulatory authorities. ISO 20022 covers a wide range of financial processes, including payments, securities, trade finance, and more. ISO 20022 is designed to replace older messaging standards, such as SWIFT Message Type (MT) and Electronic Data Interchange for Administration, Commerce, and Transport (EDIFACT), with a more modern and flexible framework.

ISO 20022, including its XML representation, differs from previous messaging standards in several significant ways. For example, ISO 20022 provides a more extensive and flexible framework for describing financial messages. ISO 20022 allows for the inclusion of a wider range of data elements and attributes, enabling more detailed and structured information to be exchanged. This flexibility is especially valuable for addressing the complex needs of modern financial transactions and regulatory requirements. ISO 20022 emphasizes structured data, which means that information is represented in a standardized, hierarchical format using XML or other syntaxes. This structured approach makes it easier to interpret and process data accurately, reducing the risk of errors and miscommunication.

In the present disclosure, the message can be generated under the ISO 20022 standard to include several kinds of information, including without limitation details about the transaction, such as the payment amount, currency, payment method, and/or merchant identification. Other information can include an internet protocol (IP) address, geolocation data, user device data, and/or time data.

Systems and methods of the present disclosure provide numerous advantages. For example, by encrypting user data and utilizing user credentials for authentication, the system significantly enhances security, reducing the risk of unauthorized access to sensitive account information. Furthermore, the system efficiently manages multiple accounts associated with different account providers, streamlining the transaction process for users with diverse financial relationships. Additionally, the use of a software application on the user's device for a second and separate authentication makes the process more user-friendly and convenient, eliminating the need for complex authentication procedures.

Systems and methods of the present disclosure optimize the transaction process by efficiently coordinating the exchange of information between the user, software application, and account providers, reducing potential delays and friction points. The systems and methods can be adapted to accommodate a variety of account providers, making them versatile and applicable to a wide range of financial institutions and services. Further, the secure and authenticated nature of the systems and methods of the present disclosure reduces the risk of fraudulent transactions, benefiting both users and account providers.

Additionally, the use of the ISO 20022 standard in particular broadens the size and variety of data that can be included in a single message to the account providers. For example, the message generated by the software application can include data about the user device and the transaction itself. This additional information gives the account providers a better understanding of the risks associated with the application. For example, the account provider can now determine, without limitation, whether the purchase has been made before, whether the purchase is being made at an unusual location, and/or whether the user has ever made a purchase on this particular user device.

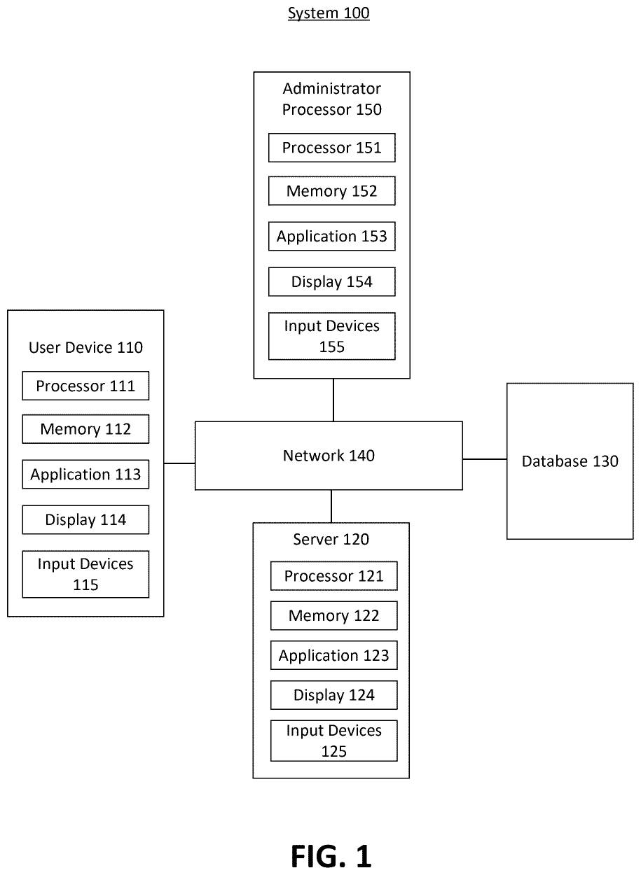

FIG. 1 illustrates a system 100 according to an exemplary embodiment. The system 100 may comprise a user device 110, a server 120, a database 130, a network 140, and an administrator processor 150. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that, for example, enable network communications with one or more components of the system 100, transmit and/or receive data, and perform the functions described herein. Upon execution by the processor 111, the application 113 may perform the functions described in this specification, specifically to execute and perform the steps and functions in the process flows described herein. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The server 120 can be onsite, offsite, standalone, networked, online, or offline.

The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that, for example, enable network communications with one or more components of the system 100, transmit and/or receive data, and perform the functions described herein. Upon execution by the processor 121, the application 123 may perform the functions described in this specification, specifically to execute and perform the steps and functions in the process flows described herein. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include a database 130. The database 130 may be one or more databases configured to store data, including without limitation, private data of users, financial accounts of users, identities of users, transactions of users, and certified and uncertified documents. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 120 or may be hosted externally of the server 120, such as by a server, by a cloud-based platform, or in any storage device that is in data communication with the server 120.

System 100 may include one or more networks 140. In some examples, the network 140 may be one or more of a wireless network, a wired network or any combination of wireless network and wired network, and may be configured to connect the user device 110, the server 120, and the database 130. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

The administrator processor 150 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The administrator processor 150 may include a processor 151, a memory 152, and an application 153. The processor 151 may be a processor, a microprocessor, or other processor, and the administrator processor 150 may include one or more of these processors.

The processor 151 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 151 may be coupled to the memory 152. The memory 152 may be a read-only memory, write-once read-multiple memory or read/write memory, e.g., RAM, ROM, and EEPROM, and the administrator processor 150 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 152 may be configured to store one or more software applications, such as the application 153, and other data, such as user's private data and financial account information.

The application 153 may comprise one or more software applications comprising instructions for execution on the administrator processor 150. In some examples, the administrator processor 150 may execute one or more applications, such as software applications, that, for example, enable network communications with one or more components of the system 100, transmit and/or receive data, and perform the functions described herein. Upon execution by the processor 151, the application 153 may perform the functions described in this specification, specifically to execute and perform the steps and functions in the process flows described herein. Such processes may be implemented in software, such as software modules, for execution by computers or other machines. The application 153 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The administrator processor 150 may further include a display 154 and input devices 155. The display 154 may be any type of device for presenting visual information such as a computer monitor, a flat panel display, and a mobile device screen, including liquid crystal displays, light-emitting diode displays, plasma panels, and cathode ray tube displays. The input devices 155 may include any device for entering information into the administrator processor 150 that is available and supported by the administrator processor 150, such as a touch-screen, keyboard, mouse, cursor-control device, touch-screen, microphone, digital camera, video recorder or camcorder. These devices may be used to enter information and interact with the software and other devices described herein.

The merchant processor 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

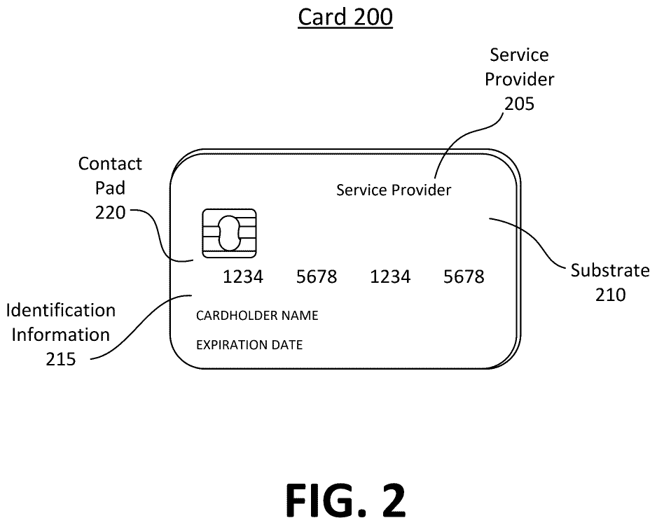

FIG. 2 illustrates a contactless card 200 according to an exemplary embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, smart watch, some other wearable device, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2).

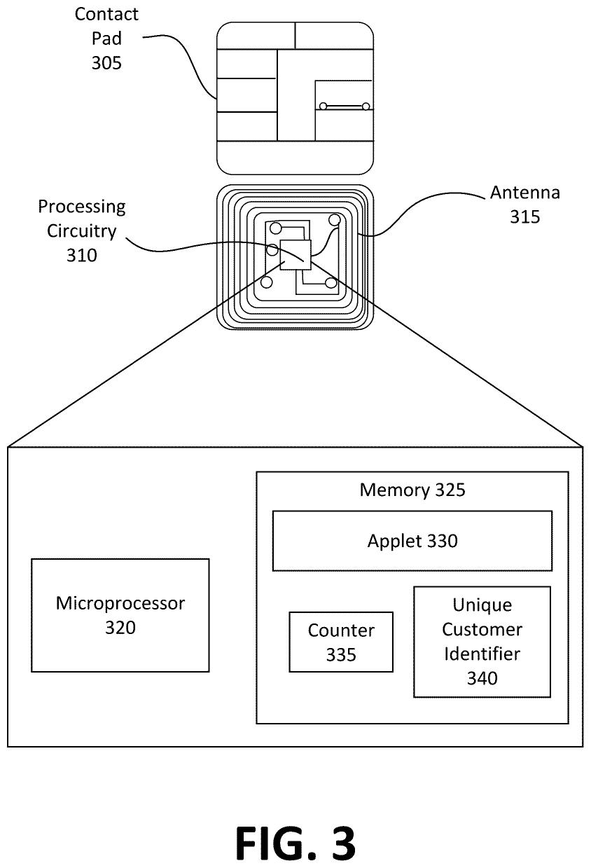

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

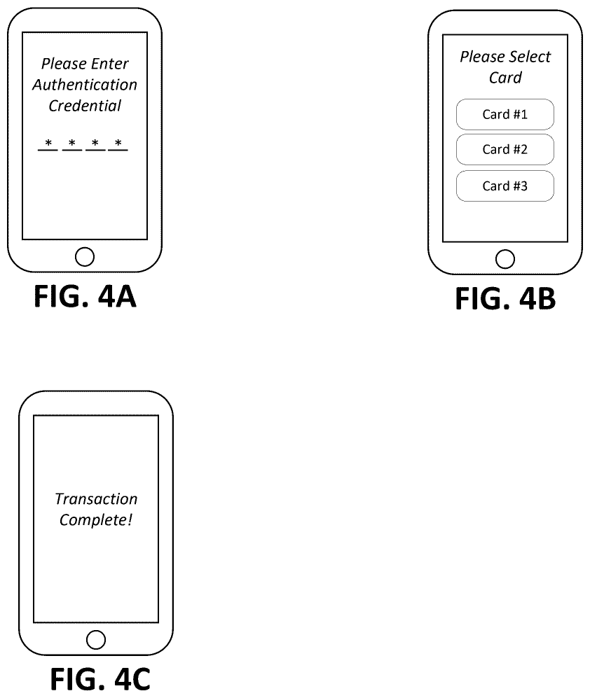

FIGS. 4A-4C illustrate user device graphical user interfaces for user authentication and account selection. In FIG. 4A, the user device receives an authentication request from the software application and submits an authentication credential, such as a personal identification number (PIN). The user device application securely communicates the entered PIN to the server using encryption protocols and secure network connections. Though only a PIN is illustrated in the graphical user interface (GUI) of FIG. 4A, it is understood that other authentication credentials may be provided, including without limitation: a biometric such as a fingerprint scan, facial recognition (e.g. face identification (face ID)), iris scanning, and voice scanning; a PIN or passcode; an OTP; or a security token.

In the GUI of FIG. 4B, the user device application receives a list of transaction accounts associated with the information provided by the user at checkout and displays the list of transaction accounts to the user. The one or more account providers will process the authentication request and retrieves the user's profile information. This includes the user's email address and other identifiers obtained from the checkout process. The software application then queries the relevant databases or systems to retrieve the list of transaction accounts associated with the user's profile. This retrieval process can involve without limitation database queries, API calls, or other mechanisms to fetch the necessary data. More specifically, the software application can integrate with the banks' APIs by establishing a connection and communicating with them. The software application sends requests to specific endpoints provided by the banks' API systems. To retrieve account information, the software application can send a GET request to the appropriate API endpoint provided by the bank. The request may include parameters such as the user's authentication credentials, account number, or any other relevant details required by the API. The bank's API processes the request and generates a response. The response usually contains the requested account information, such as the account balance, transaction history, or other relevant data. The software application can store the retrieved account information in a database or use it for further processing, analysis, or display within the application. The software application can also aggregate data from multiple banks if needed, by making separate API requests to each bank's API and consolidating the responses.

Furthermore, the one or more accounts provided by the bank or account providers can be associated with one or more transaction cards such as credit cards, charge cards, debit cards, gift cards, rewards cards, or some other transaction card. In some embodiments, the bank and the software application share information regarding the one or more transaction accounts associated with the user. In some embodiments, the software application may query the bank through the API for each individual online transaction, e.g. the software application may make separate requests for payment credentials for each transaction. In other embodiments, the software application may have a relationship with the bank such that the payment credentials usually handled by the bank will be possessed by the software application as well. That is, the software application already has the payment credentials, so the software application does not have to query the bank for every single transaction. This embodiment presumes that the server and the bank have already communicated with one another and have granted the software application the permission to have and use the payment credentials associated with one or more transaction accounts associated with the user. In some embodiments, the software application may query the bank through the API for each individual online transaction, e.g. the software application may make separate requests for payment credentials for each transaction. In other embodiments, the software application may have a relationship with the bank such that the payment credentials usually handled by the bank will be possessed by the server as well. That is, the server already has the payment credentials, so the software application does not have to query the bank for every single transaction. This embodiment presumes that the software application and the bank have already communicated with one another and have granted the software application the permission to have and use the payment credentials associated with one or more transaction accounts associated with the user.

Once retrieved, the software application transmits the list of transaction accounts to the user's user device application using secure communication channels and data serialization formats such as JSON or XML. The list can be shown on the user device's display, and the user can select one of many account. In FIG. 4B, the user can choose from one of three options labeled “Card #1,” “Card #2,” and “Card #3.” In other embodiments, the user can be provided with more or fewer selections. Each card can be associated with one or more transaction accounts associated with potentially one or more account providers.

Once the user selects the card, as illustrated in the GUI of in FIG. 4C, the user has selected a transaction account from the list, and the software application performs the transaction with the selected account. When the user selects a card from the list of transaction accounts on their user device application, the application securely communicates the user's selection back to the software application. The software application receives the user's choice and initiates the transaction process. This involves interacting with payment gateways, financial institutions, or other relevant systems to authorize and process the transaction. The software application securely communicates the transaction details and payment information to the appropriate parties involved, such as the card issuer or the acquiring bank, to complete the transaction. Once the transaction is processed and confirmed, the software application notifies the user device application and/or application about the transaction's completion, providing a confirmation message or status update that is visible on the display of the user device.

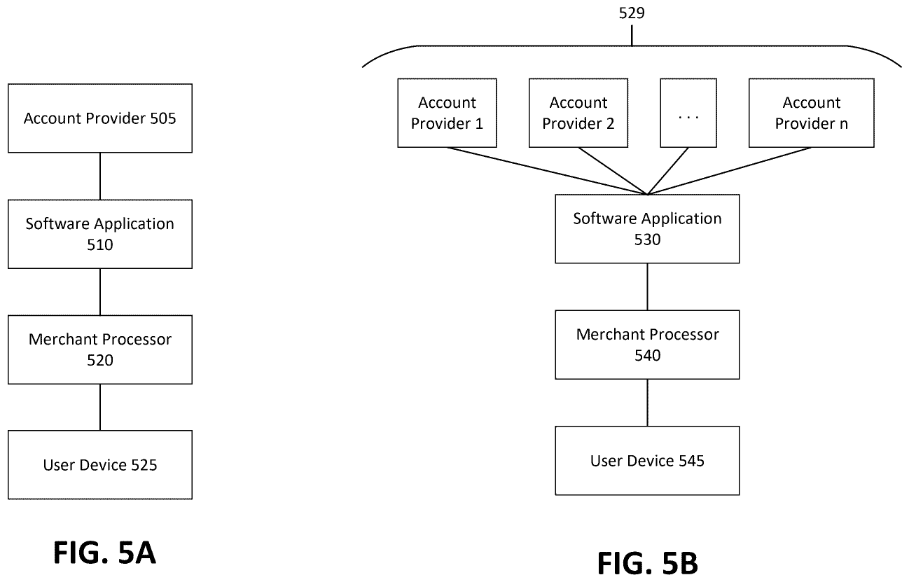

FIGS. 5A and 5B describe two embodiments of exemplary systems. In FIG. 5A, the software application 510 is connected to a single account provider 505. An account provider can include a processor or server associated with a provider of personal financing and payment services, including without limitation, checking accounts, savings accounts, credit accounts, or some combination thereof. For example, an account provider can include the credit card provider associated with a user's credit card. The software application 510 can also be connected to a merchant processor 520 and a user device 525 over a network discussed with further reference to FIG. 1. The single account provider 505 can be associated with a bank or banking application including one or more transaction accounts such as a checking, savings, or growth accounts. Furthermore, the accounts can be associated with one or more transaction cards such as credit cards, charge cards, debit cards, gift cards, rewards cards, or some other transaction card. In this embodiment, the account provider 505 and the software application 510 share information regarding the one or more transaction accounts associated with the account provider 505. In some embodiments, the software application 510 may query the account provider 505 for each individual online transaction, e.g., the software application 510 may make separate requests for payment credentials for each transaction. In other embodiments, the software application 510 may have a relationship with the account provider 505 such that the payment credentials usually handled by the account provider 505 will be processed by the software application 510 as well. That is, the software application 510 already has the payment credentials, so the software application 510 does not have to query the account provider 505 for every single transaction. This embodiment presumes that the software application 510 and account provider 505 have already communicated with one another and have granted the software application 510 the permission to have and use the payment credentials associated with one or more transaction accounts associated with the account provider 205.

In an exemplary embodiment, the user device 525 can be used to initiate an online consumer transaction associated with a particular merchant. The particular merchant can have a merchant processor 520. When the user device 525 initiates the online transaction, the merchant processor 520 can gather one or more information items about the transaction, including without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof.

In FIG. 5B, the software application 530 can similarly be in communication with a merchant processor 540 and a user device 545 over one or more networks discussed with further reference to FIG. 1. In this embodiment, the software application 530 can be associated with multiple account providers 529, for example Account Provider 1, Account Provider 2, . . . , up to Account Provider n. The account providers 529 can each be associated with a bank or banking application including one or more transaction accounts such as a checking, savings, or growth accounts. Furthermore, the accounts can be associated with one or more transaction cards such as credit cards, charge cards, debit cards, gift cards, rewards cards, or some other transaction card. In some embodiments, the software application 510 may query the account providers 529 for each individual online transaction, e.g., the software application 510 may make separate requests for payment credentials for each transaction. In other embodiments, the software application 530 may have a relationship with the account providers 529 such that the payment credentials usually handled by the account providers 529 will be processed by the software application 530 as well. That is, the software application 530 already has the payment credentials, so the software application 530 does not have to query the account providers 529 for every single transaction. This embodiment presumes that the software application 530 and account providers 529 have already communicated with one another and have granted the software application 530 the permission to have and use the payment credentials associated with one or more transaction accounts associated with the account providers 529.

In an exemplary embodiment, the user device 545 can be used to initiate an online consumer transaction associated with a particular merchant. The particular merchant can have a merchant processor 540. When the user device 545 initiates the online transaction, the merchant processor 540 can gather one or more information items about the transaction, including without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof.

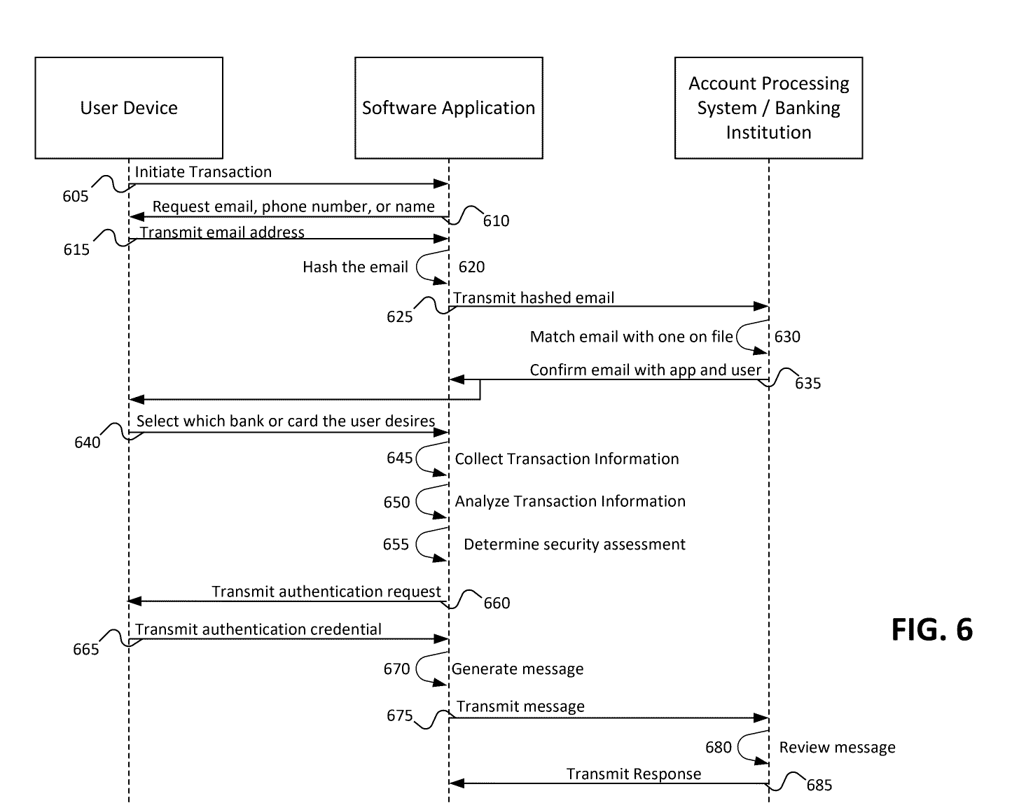

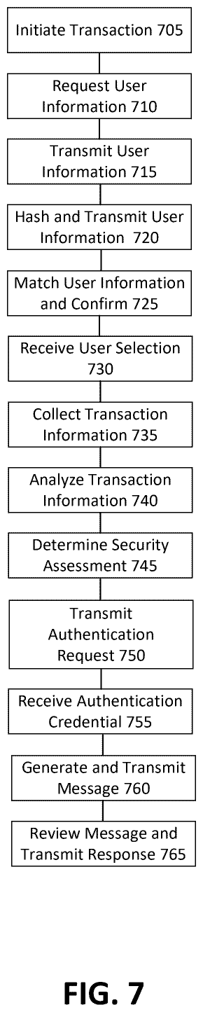

FIG. 6 illustrates a sequence diagram of an exemplary embodiment. In the embodiment of sequence 600, the software application is associated with a merchant, and the account processing system is associated with a banking institution holding a contactless card account for the user. The banking institution may be one of multiple banks partnering with the merchant to provide secure account holder identification through the use of shared datum encryption information and/or method and an agreed-upon user datum. It is understood that the banking institutions may use a web application or mobile application to verify the user authentication credential.

In action 605, the user device initiates a transaction. This action can be performed by a processor associated with the user device or a server, and it can be transmitted over a network.

In action 610, the software application requests from the user personal identity information including, at least, the agreed-upon user datum. Examples of personal identity information can include without limitation email addresses, phone number, or names. In action 615, the user device responds to the request with the appropriate information including the user datum. Although FIG. 6 illustrates the user datum as an email address, it is understood that other personal information may be used.

In action 620, the software application hashes the user datum provided by the user. This protects the identity information associated with the user. In action 625, the software application transmits the hashed user datum to one or more banking institutions. It is understood that the software application may have a pre-existing relationship with one more banking institutions so that transmission occurs more quickly. The software application can prompt the user to select particular banking institutions he wishes to send the hashed email.

In action 630, one or more banking institutions can compare the hashed datum from the software application with hashed datum values previously established using the shared encryption information and/or method and user data for account holders. This step can be performed by a processor associated with the software application. If the banking institution matches the hashed datum with a hashed datum on file, this means that the user has an existing account associated with the banking institution. The existing account can be a spending account, growth account, or savings account.

After matching the user's datum with one on file, one or more banking institutions transmits a confirmation message or confirmation response to the software application and user device in action 635, or alternatively just the software application. This action can be performed by a processor associated with the banking institution. In some embodiments, the confirmation message may be sent to the user device via the software application. In other embodiments, the confirmation message may be sent directly to the user device and not to the software application. If multiple banks have confirmed the datum, then the user can select which account the user desires to use and the user device transmits the selection to the software application in action 640. This allows for greater spending freedom for the user. This action may be performed by a processor associated with the user device or a server.

Upon receiving a selection from the user, the software application may send a notification to the selected bank. Once the user has selected which bank or account provider he wishes to use, in action 645 the software application can collect one or more transaction data associated with the user, user device, and the transaction itself. This data may have been already collected by the software application, for example the software application may already know the name, email address, telephone number, and user device when the user initially downloaded the application. Otherwise, the software application may observe where the user has inputted such information during the checkout process associated with the transaction. Furthermore, the software application can observe details about the transaction itself, such as the product being purchased, the price, the merchant, the merchant category, the time of purchase, and geolocation data such as the shipping address and location of the user device at the time of purchase. The software application may utilize a browser extension, a software development kit (SDK), or other suitable means to observe and collect this information.

The software application can analyze the collected information (action 650) and determine a security assessment based on the analysis (action 655). For example, the software application can determine a security assessment of the transaction profile information, the software application can determine, based on the given transaction profile information, the likelihood of fraud associated with the present online transaction. The software application can make this determination based on whether the transaction profile alone or in combination should be associated with fraudulent activity. For example, the software application can determine that the IP address associated with the user device is far away from the user device's historical geolocation data.

In other nonlimiting embodiments, the software application can collect user behaviors associated with performing transactions including without limitation: spending history associated with the user and the merchant; purchase patterns; Wi-Fi networks; browser configurations; and other user behaviors. For example, the software application can identify the Wi-Fi network associated with the user's device, then determine if the identified network matches the network historically used by the user device, most often used by the user, or a network that has ever been used by the user device.

In still other embodiments, user behavior can include, for example, spending history associated with the merchant. As other examples, the user behavior can include, without limitation, repetition of purchases, how often purchases occurred with respect to the merchant, and/or general price range associated with the user's purchase history.

In other embodiments, the software application can compress the data present on the checkout page, which can be a highly entropic image, to identify a phone or computer graphical processing unit (GPU) and thus identify the user device associated with the transaction. The software application can acquire one or more images from the target phone or computer. These images should have high entropy, containing complex patterns or seemingly random data, which will make the identification process more effective. The acquired images are then subjected to a compression process. Compression algorithms are used to reduce the size of the image files while attempting to retain as much essential information as possible. Different compression methods may be used, such as lossless or lossy compression. During the compression process, artifacts may be introduced into the images. Artifacts are distortions or irregularities that occur due to the compression algorithm. These artifacts can be unique to the specific compression process used by the GPU of the phone or computer. In order to identify the device, a reference database may be created. This database contains information about the compression artifacts generated by various GPUs on different phones and computers. Each entry in the database corresponds to a specific device-GPU combination. The compression artifacts in the compressed images are analyzed to extract specific features that are indicative of the GPU used for compression. These features may include patterns, noise, or other characteristics that are unique to the GPU's compression process. The extracted features are then compared to the reference database. The compression algorithm tries to find the best match between the features extracted from the compressed image and the entries in the reference database. If a close match is found, it indicates that the compressed image is likely processed by the GPU associated with that entry. Once a match is found in the reference database, the algorithm can infer the phone or computer's make and model, as well as the specific GPU used for compression.

Having reviewed the transaction profile information, the software application can grade the online transaction on a scale of low risk, medium risk, and high risk. In other embodiments, the software application may only grade for low risk or high risk. In still other embodiments, the software application can generate a numerical score or letter grade each with discrete value. In still other embodiments, the software application can generate a slidable scale of riskiness associated with the online transaction.

In action 660, the software application transmits an authentication request or confirmation authentication request to the user. The authentication request is meant to verify the user's identity, his or her information, and generally to protect against fraud. This action may be also performed by a processor associated with the bank or some other server.

In response to the authentication request, the user can send one or more authentication credentials or confirmation responses to the software application in action 665. The credentials can include without limitation an OTP, a PIN, or a biometric. It is understood that one or more credential can be used and that multi-factor information may be used as well. This action can be performed by a processor associated with the user device. The authentication credential can be transmitted over a network to the software application which can also verify the authentication credential. In alternative embodiments, the user may transmit the authentication credential directly to the banking institution.

Having received the authentication credential, in action 670 the software application can generate a message comprising one, some, or all of the information gathered about the transaction, the user, and the user device.

The software application, having gathered a comprehensive array of information pertaining to the user device, the user, and the specific transaction at hand, generates a message to be sent to the bank and/or account provider. In some embodiments, the message generation begins by organizing the data points into a coherent and structured format. Firstly, it assembles transaction-specific details, including but not limited to the transaction amount, merchant information, a timestamp marking the moment of initiation, and any relevant transaction references or codes. Simultaneously, the software application incorporates essential user-related information, such as user identification credentials, authentication tokens, and user preferences, which significantly contribute to personalizing the message. In some embodiments, the gathered data is then meticulously organized in accordance with the ISO 20022 standard, ensuring adherence to the established schema and guidelines. This process involves defining the appropriate XML elements and tags to encapsulate each piece of information accurately. Additionally, the software application can in some embodiments incorporate security measures, such as digital signatures and encryption, to safeguard the message's integrity and confidentiality during transmission.

Having generated the message, in action 675 the software application can transmit the message to the account provider over a secure network. In action 680, the account provider can review the message and determination, based on the content of the message, how the transaction should proceed. If the account provider is satisfied that the information present in the message indicates a high level of security or a low level of risk of fraud, then the account provider may determine that the transaction should proceed. If not, the account provider may determine that the transaction should not proceed, e.g. that payment credential should ultimately not be provided to the merchant. In action 685, the account provider can transmit the response to the software application. In some embodiments, the account provider may determine that a subsequent authentication should happen based on the risk assessment from the software application. In still other embodiments, the account systems can request another credential from the user via the user device. The credential can include a biometric such as a fingerprint scan, facial recognition (e.g. face ID), iris scanning, and voice scanning; a PIN or passcode; or a security token. The software application can independently verify the second authentication credential and share the verification with the user device.

FIG. 7 illustrates a method of providing secure account holder identification according to an exemplary embodiment. In the embodiment of method 700, the software application is associated with a merchant, and the account processing system is associated with a banking institution holding a contactless card account for the user. The banking institution may be one of multiple banks partnering with the merchant to provide secure account holder identification through the use of shared datum encryption information and/or method and an agreed-upon user datum. It is understood that the banking institutions may use a web application or mobile application to verify the user authentication credential.

In step 705, the user device initiates a transaction. This step can be performed by a processor associated with the user device or a server, and it can be transmitted over a network.

In step 710, the software application requests from the user personal identity information including, at least, the agreed-upon user datum. Examples of personal identity information can include without limitation email addresses, phone number, and/or names. In step 715, the user device responds to the request with the appropriate information including the user datum.

In step 720, the software application hashes the user datum provided by the user. This protects the identity information associated with the user. The software application transmits the hashed user datum to one or more banking institutions. It is understood that the software application may have a pre-existing relationship with one more banking institutions so that transmission occurs more quickly. The software application can prompt the user to select particular banking institutions he wishes to send the hashed email.

In step 725, one or more banking institutions can compare the hashed datum from the software application with hashed datum values previously established using the shared encryption information and/or method and user data for account holders. This step can be performed by a processor associated with the software application. If the banking institution matches the hashed datum with a hashed datum on file, this means that the user has an existing account associated with the banking institution. The existing account can be a spending account, growth account, or savings account.

After matching the user's datum with one on file, one or more banking institutions transmits a confirmation message or confirmation response to the software application and user device, or alternatively just the software application. This step can be performed by a processor associated with the banking institution. In some embodiments, the confirmation message may be sent to the user device via the software application. In other embodiments, the confirmation message may be sent directly to the user device and not to the software application.

If multiple banks have confirmed the datum, then the user can select which account the user desires to use and the user device transmits the selection to the software application in step 730 and for transmission to the selected bank. This allows for greater spending freedom for the user. This step may be performed by a processor associated with the user device or a server. Upon receiving a selection from the user, the software application may send a notification to the selected bank.

Once the user has selected which bank or account provider he wishes to use, in step 735 the software application can collect one or more transaction data associated with the user, user device, and the transaction itself. This data may have been already collected by the software application, for example the software application may already know the name, email address, telephone number, and user device when the user initially downloaded the application. Otherwise, the software application may observe where the user has inputted such information during the checkout process associated with the transaction. Furthermore, the software application can observe details about the transaction itself, such as the product being purchased, the price, the merchant, the merchant category, the time of purchase, and geolocation data such as the shipping address and location of the user device at the time of purchase. The software application may utilize a browser extension, a software development kit (SDK), or other suitable means to observe and collect this information.

The software application can analyze the collected information (step 740) and determine a security assessment based on the analysis (step 745). For example, the software application can determine a security assessment of the transaction profile information, the software application can determine, based on the given transaction profile information, the likelihood of fraud associated with the present online transaction. The software application can make this determination based on whether the transaction profile alone or in combination should be associated with fraudulent activity. For example, the software application can determine that the IP address associated with the user device is far away from the user device's historical geolocation data.

In other nonlimiting embodiments, the software application can collect user behaviors associated with performing transactions including without limitation: spending history associated with the user and the merchant; purchase patterns; Wi-Fi networks; browser configurations; and other user behaviors. For example, the software application can identify the Wi-Fi network associated with the user's device, then determine if the identified network matches the network historically used by the user device, most often used by the user, or a network that has ever been used by the user device.

In still other embodiments, user behavior can include, for example, spending history associated with the merchant. As other examples, the user behavior can include, without limitation, repetition of purchases, how often purchases occurred with respect to the merchant, and/or general price range associated with the user's purchase history.

In other embodiments, the software application can compress the data present on the checkout page, which can be a highly entropic image, to identify a phone or computer graphical processing unit (GPU) and thus identify the user device associated with the transaction. The software application can acquire one or more images from the target phone or computer. These images should have high entropy, containing complex patterns or seemingly random data, which will make the identification process more effective. The acquired images are then subjected to a compression process. Compression algorithms are used to reduce the size of the image files while attempting to retain as much essential information as possible. Different compression methods may be used, such as lossless or lossy compression. During the compression process, artifacts may be introduced into the images. Artifacts are distortions or irregularities that occur due to the compression algorithm. These artifacts can be unique to the specific compression process used by the GPU of the phone or computer. In order to identify the device, a reference database may be created. This database contains information about the compression artifacts generated by various GPUs on different phones and computers. Each entry in the database corresponds to a specific device-GPU combination. The compression artifacts in the compressed images are analyzed to extract specific features that are indicative of the GPU used for compression. These features may include patterns, noise, or other characteristics that are unique to the GPU's compression process. The extracted features are then compared to the reference database. The compression algorithm tries to find the best match between the features extracted from the compressed image and the entries in the reference database. If a close match is found, it indicates that the compressed image is likely processed by the GPU associated with that entry. Once a match is found in the reference database, the algorithm can infer the phone or computer's make and model, as well as the specific GPU used for compression.

Having reviewed the transaction profile information, the software application can grade the online transaction on a scale of low risk, medium risk, and high risk. In other embodiments, the software application may only grade for low risk or high risk. In still other embodiments, the software application can generate a numerical score or letter grade each with discrete value. In still other embodiments, the software application can generate a slidable scale of riskiness associated with the online transaction.

In step 750, the software application transmits an authentication request or confirmation authentication request to the user. The authentication request is meant to verify the user's identity, his or her information, and generally to protect against fraud. This step may be also performed by a processor associated with the bank or some other server.

In response to the authentication request, the user can send one or more authentication credentials or confirmation responses to the software application in step 755. The credentials can include without limitation an OTP, a PIN, or a biometric. It is understood that one or more credential can be used and that multi-factor information may be used as well. This step can be performed by a processor associated with the user device. The authentication credential can be transmitted over a network to the software application which can also verify the authentication credential. In alternative embodiments, the user may transmit the authentication credential directly to the banking institution.

Having received the authentication credential, in step 760 the software application can generate a message comprising one, some, or all of the information gathered about the transaction, the user, and the user device.

The software application, having gathered a comprehensive array of information pertaining to the user device, the user, and the specific transaction at hand, generates a message to be sent to the bank and/or account provider. In some embodiments, the message generation begins by organizing the data points into a coherent and structured format. Firstly, it assembles transaction-specific details, including but not limited to the transaction amount, merchant information, a timestamp marking the moment of initiation, and any relevant transaction references or codes. Simultaneously, the software application incorporates essential user-related information, such as user identification credentials, authentication tokens, and user preferences, which significantly contribute to personalizing the message. In some embodiments, the gathered data is then meticulously organized in accordance with the ISO 20022 standard, ensuring adherence to the established schema and guidelines. This process involves defining the appropriate XML elements and tags to encapsulate each piece of information accurately. Additionally, the software application can in some embodiments incorporate security measures, such as digital signatures and encryption, to safeguard the message's integrity and confidentiality during transmission.

Having generated the message, in step 765 the software application can transmit the message to the account provider over a secure network. The account provider can review the message and determination, based on the content of the message, how the transaction should proceed. If the account provider is satisfied that the information present in the message indicates a high level of security or a low level of risk of fraud, then the account provider may determine that the transaction should proceed. If not, the account provider may determine that the transaction should not proceed, e.g. that payment credential should ultimately not be provided to the merchant. The account provider can transmit the response to the software application. In some embodiments, the account provider may determine that a subsequent authentication should happen based on the risk assessment from the software application. In still other embodiments, the account systems can request another credential from the user via the user device. The credential can include a biometric such as a fingerprint scan, facial recognition (e.g. face ID), iris scanning, and voice scanning; a PIN or passcode; or a security token. The software application can independently verify the second authentication credential and share the verification with the user device.

In some aspects, the techniques described herein relate to a system for authenticating a user for a transaction, the system including: a software application configured to: receive, from a user device associated with an account holder associated with a bank, a transaction request; receive, from the user device, a user datum associated with the account holder; encrypt the user datum using user datum encryption information; transmit to each of a plurality of account processing systems a user account query including the encrypted user datum, wherein each account processing system is associated with a different account provider and has been provisioned with the user datum encryption information; receive, by the software application from at least one of the plurality of account processing systems, a response including a notification that the account holder has a transaction account processed by that account processing system; transmit, by the software application to the user device, a confirmation request identifying the account providers associated with the at least one of the plurality of account processing systems; receive, by the software application from the user device, a confirmation response including identification of a selected account provider; collect, from a merchant processor, transaction profile information associated with the transaction; analyze the transaction profile information; determine, based on the analysis of the transaction profile information, a security assessment of the transaction, wherein the security assessment indicates a measure of security associated with the transaction; transmit to the user device upon determining that the transaction is insecure, an authentication request; receive, from the user device, a user authentication credential; generate a message including a plurality of details about the transaction; transmit the message to the selected account provider; and receive, from the selected account provider, a response including either an authorization of the transaction or a rejection of the transaction.

In some aspects, the techniques described herein relate to a system, wherein the user datum is one of the set consisting of a phone number, a name, and an email address.

In some aspects, the techniques described herein relate to a system, wherein the at least one authentication credential includes multi-factor information associated with the user account.

In some aspects, the techniques described herein relate to a system, wherein the at least one authentication credential includes encrypted information received by the user device from a contactless card associated with the transaction account associated with the selected account provider.

In some aspects, the techniques described herein relate to a system, wherein the confirmation request includes an instruction to display a list of the account providers associated with the at least one of the plurality of account processing systems.

In some aspects, the techniques described herein relate to a system, wherein the message includes at least one selected from the group of an IP address, shipping address, and one or more credit card data.

In some aspects, the techniques described herein relate to a system, wherein the software application is further configured to receive a request from the account provider to request a second authentication credential from the user device.

In some aspects, the techniques described herein relate to a system, wherein the software application is further configured to receive a request from the account provider to decline the transaction.

In some aspects, the techniques described herein relate to a system, wherein the software application is further configured to generate a unique session identifier for the transaction and includes it in the message.

In some aspects, the techniques described herein relate to a method for authenticating a user for a transaction, the method including the steps of: receiving, by the software application from a user device associated with an account holder associated with a bank, a transaction request; receiving, by the software application from the user device, a user datum associated with the account holder; encrypting, by the software application, the user datum using user datum encryption information; transmitting by the software application to each of a plurality of account processing systems a user account query including the encrypted user datum; receiving, by the software application from at least one of the plurality of account processing systems, a response including a notification that the account holder has a transaction account processed by that account processing system; transmitting, by the software application to the user device, a confirmation request identifying the account providers associated with the at least one of the plurality of account processing systems; receiving, by the software application from the user device, a confirmation response including identification of a selected account provider; collecting, by the software application from a merchant processor, transaction profile information associated with the transaction; analyzing by the software application the transaction profile information; determining, by the software application based on the analysis of the transaction profile information, a security assessment of the transaction, wherein the security assessment indicates a measure of security associated with the transaction; transmitting by the software application to the user device upon determining that the transaction is insecure, an authentication request; receiving, from the user device, a user authentication credential; generating by the software application a message including a plurality of details about the transaction; transmitting the message to the selected account provider; and receiving, by the software application from the selected account provider, a response including either an authorization of the transaction or a rejection of the transaction.

In some aspects, the techniques described herein relate to a method, wherein the message includes at least one selected from the group of an IP address, shipping address, and one or more credit card data.

In some aspects, the techniques described herein relate to a method, wherein the message includes at least one selected from the group of a time datum, user device datum, and geolocation datum.

In some aspects, the techniques described herein relate to a method, wherein the transaction profile information includes at least one of the following: transaction amount, transaction type, merchant identity, and geographic location.

In some aspects, the techniques described herein relate to a method, wherein the method further includes transmitting, to the user device, a notification indicating that the transaction has been authorized.

In some aspects, the techniques described herein relate to a method, further including notifying the user device of the rejection of the transaction and providing a reason for the rejection when the response from the selected account provider indicates a rejection of the transaction.

In some aspects, the techniques described herein relate to a method, further including determining that the transaction is insecure if a geolocation datum associated with the transaction deviates from one or more historical geolocation datum associated with the account holder.

In some aspects, the techniques described herein relate to a method, wherein each account processing system is associated with a different account provider and has been provisioned with the user datum encryption information.

In some aspects, the techniques described herein relate to a method, wherein the software application can further receive from the account provider a request to provide a second authentication credential from the user device.

In some aspects, the techniques described herein relate to a method, further including notifying the user device of potential security risks associated with the transaction before proceeding with authentication

In some aspects, the techniques described herein relate to a non-transitory computer readable medium containing computer executable instructions that, when executed by a computer hardware arrangement, cause the computer hardware arrangement to perform procedures including: receiving, from a user device associated with an account holder associated with a bank, a transaction request; receiving, from the user device, a user datum associated with the account holder; encrypting the user datum using user datum encryption information; transmitting to each of a plurality of account processing systems a user account query including the encrypted user datum; receiving, from at least one of the plurality of account processing systems, a response including a notification that the account holder has a transaction account processed by that account processing system; transmitting, to the user device, a confirmation request identifying the account providers associated with the at least one of the plurality of account processing systems; receiving, from the user device, a confirmation response including identification of a selected account provider; collecting, from a merchant processor, transaction profile information associated with the transaction; analyzing the transaction profile information; determining, based on the analysis of the transaction profile information, a security assessment of the transaction, wherein the security assessment indicates a measure of security associated with the transaction; transmitting to the user device upon determining that the transaction is insecure, an authentication request; receiving, from the user device, a user authentication credential; generating a message including a plurality of details about the transaction; transmitting the message to the selected account provider; and receiving, from the selected account provider, a response including either an authorization of the transaction or a rejection of the transaction.

In some examples, the present disclosure refers to a transaction involving a banking or banking institution, which may include, without limitation, banks and financial institutions. However, it is understood that the terms bank and banking institution are not limited thereto, and the present disclosure can include any type of merchant, vendor, or other entity involving in activities where products or services are sold or otherwise provided, either online, in a physical location, or both.

As used herein, user information or personal information can include any data relating to a user. This can include sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. This can also included non-sensitive data, including publicly-known information.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (e.g., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for authenticating a user for a transaction, the system comprising:
a software application configured to:
receive, from a user device associated with an account holder associated with a bank, a transaction request;
receive, from the user device, a user datum associated with the account holder;
encrypt the user datum using user datum encryption information;
transmit to each of a plurality of account processing systems a user account query including the encrypted user datum, wherein each account processing system is associated with a different account provider and has been provisioned with the user datum encryption information;
receive, by the software application from at least one of the plurality of account processing systems, a response comprising a notification that the account holder has a transaction account processed by that account processing system;
transmit, by the software application to the user device, a confirmation request identifying the account providers associated with the at least one of the plurality of account processing systems;
receive, by the software application from the user device, a confirmation response including identification of a selected account provider;
collect, from a merchant processor, transaction profile information associated with the transaction;
analyze the transaction profile information;
determine, based on the analysis of the transaction profile information, a security assessment of the transaction, wherein the security assessment indicates a measure of security associated with the transaction;
transmit to the user device upon determining that the transaction is insecure, an authentication request;
receive, from the user device, a user authentication credential;
generate a message comprising a plurality of details about the transaction;
transmit the message to the selected account provider; and
receive, from the selected account provider, a response comprising either an authorization of the transaction or a rejection of the transaction.

2. The system of claim 1, wherein the user datum is one of the set consisting of a phone number, a name, and an email address.

3. The system of claim 1, wherein the at least one authentication credential includes multi-factor information associated with the user account.

4. The system of claim 1, wherein the at least one authentication credential includes encrypted information received by the user device from a contactless card associated with the transaction account associated with the selected account provider.

5. The system of claim 1, wherein the confirmation request includes an instruction to display a list of the account providers associated with the at least one of the plurality of account processing systems.

6. The system of claim 1, wherein the message includes at least one selected from the group of an IP address, shipping address, and one or more credit card data.

7. The system of claim 1, wherein the software application is further configured to receive a request from the account provider to request a second authentication credential from the user device.

8. The system of claim 1, wherein the software application is further configured to receive a request from the account provider to decline the transaction.

9. The system of claim 1, wherein the software application is further configured to generate a unique session identifier for the transaction and includes it in the message.

10. A method for authenticating a user for a transaction, the method comprising the steps of:
receiving, by the software application from a user device associated with an account holder associated with a bank, a transaction request;
receiving, by the software application from the user device, a user datum associated with the account holder;
encrypting, by the software application, the user datum using user datum encryption information;
transmitting by the software application to each of a plurality of account processing systems a user account query including the encrypted user datum;
receiving, by the software application from at least one of the plurality of account processing systems, a response comprising a notification that the account holder has a transaction account processed by that account processing system;
transmitting, by the software application to the user device, a confirmation request identifying the account providers associated with the at least one of the plurality of account processing systems;
receiving, by the software application from the user device, a confirmation response including identification of a selected account provider;
collecting, by the software application from a merchant processor, transaction profile information associated with the transaction;
analyzing by the software application the transaction profile information;
determining, by the software application based on the analysis of the transaction profile information, a security assessment of the transaction, wherein the security assessment indicates a measure of security associated with the transaction;
transmitting by the software application to the user device upon determining that the transaction is insecure, an authentication request;
receiving, from the user device, a user authentication credential;
generating by the software application a message comprising a plurality of details about the transaction;
transmitting the message to the selected account provider; and
receiving, by the software application from the selected account provider, a response comprising either an authorization of the transaction or a rejection of the transaction.

11. The method of claim 10, wherein the message includes at least one selected from the group of an IP address, shipping address, and one or more credit card data.

12. The method of claim 10, wherein the message includes at least one selected from the group of a time datum, user device datum, and geolocation datum.

13. The method of claim 10, wherein the transaction profile information includes at least one of the following: transaction amount, transaction type, merchant identity, and geographic location.

14. The method of claim 10, wherein the method further comprises transmitting, to the user device, a notification indicating that the transaction has been authorized.

15. The method of claim 10, further comprising notifying the user device of the rejection of the transaction and providing a reason for the rejection when the response from the selected account provider indicates a rejection of the transaction.

16. The method of claim 10, further comprising determining that the transaction is insecure if a geolocation datum associated with the transaction deviates from one or more historical geolocation datum associated with the account holder.

17. The method of claim 10, wherein each account processing system is associated with a different account provider and has been provisioned with the user datum encryption information.

18. The method of claim 10, wherein the software application can further receive from the account provider a request to provide a second authentication credential from the user device.

19. The method of claim 10, further comprising notifying the user device of potential security risks associated with the transaction before proceeding with authentication.

20. A non-transitory computer readable medium containing computer executable instructions that, when executed by a computer hardware arrangement, cause the computer hardware arrangement to perform procedures comprising:
receiving, from a user device associated with an account holder associated with a bank, a transaction request;
receiving, from the user device, a user datum associated with the account holder;
encrypting the user datum using user datum encryption information;
transmitting to each of a plurality of account processing systems a user account query including the encrypted user datum;
receiving, from at least one of the plurality of account processing systems, a response comprising a notification that the account holder has a transaction account processed by that account processing system;
transmitting, to the user device, a confirmation request identifying the account providers associated with the at least one of the plurality of account processing systems;
receiving, from the user device, a confirmation response including identification of a selected account provider;
collecting, from a merchant processor, transaction profile information associated with the transaction;
analyzing the transaction profile information;
determining, based on the analysis of the transaction profile information, a security assessment of the transaction, wherein the security assessment indicates a measure of security associated with the transaction;
transmitting to the user device upon determining that the transaction is insecure, an authentication request;
receiving, from the user device, a user authentication credential;
generating a message comprising a plurality of details about the transaction;
transmitting the message to the selected account provider; and
receiving, from the selected account provider, a response comprising either an authorization of the transaction or a rejection of the transaction.
